(19) United States
(12) Patent Application Publication
(10) Pub. No.: US 2019/0327379 A1
(43) Pub. Date: Oct. 24, 2019

(54) SERVER FOR PROVIDING E-MAIL PRINTING SERVICE AND METHOD FOR OPERATING SAME SERVER

(71) Applicant: Hewlett-Packard Development Company, L.P., Spring, TX (US)

(72) Inventors: Hong-seock KIM, Suwon-si (KR); Chang-seok CHOI, Suwon-si (KR); Tae-jung YUN, Suwon-si (KR); Hyun-chul YU, Suwon-si (KR)

(21) Appl. No.: 16/458,516

(22) Filed: Jul. 1, 2019

Related U.S. Application Data
(63) Continuation of application No. PCT/KR2017/002109, filed on Feb. 27, 2017.

(30) Foreign Application Priority Data
Jan. 4, 2017 (KR) 10-2017-0001313

(51) Int. Cl. H04N 1/32; H04N 1/00; G06F 3/12

(52) U.S. Cl. CPC H04N 1/32096; H04N 1/00212; G06F 3/1222; H04N 2201/0094; G06F 3/1268; H04N 1/00244; G06F 3/1238

(57) ABSTRACT

A server and an operating method for an e-mail printing service are provided. The operating method includes receiving an e-mail to be sent to an e-mail address of an image forming apparatus, determining whether the received e-mail is a confirmation request e-mail for confirming whether the e-mail address of the image forming apparatus is correct, creating a reply e-mail when the received e-mail is the confirmation request e-mail, the reply e-mail indicating that the e-mail address of the image forming apparatus is correct, and returning the reply e-mail to a sender address of the received e-mail.

### BACKGROUND

In an e-mail printing service, a user registers a printer in the e-mail printing service to receive a printer-specific e-mail. When the user sends a document to be printed to the e-mail address of the registered printer, the printer receives the e-mail and prints the text content of the e-mail or prints an attached file. The e-mail printing service enables a printing job by sending an e-mail without a user having to install a program or an application separately.

To send the e-mail, an e-mail address of a recipient must be input. For the e-mail address of the recipient, any character or number can be input as a text input and thus there is a possibility for a user to incorrectly input the e-mail address of a recipient. If a user inputs an incorrect e-mail address, important documents may be leaked or incorrectly sent.

### BRIEF DESCRIPTION OF DRAWINGS

FIG. 1 is a view of a system for providing an e-mail printing service according to an example;

FIG. 2 is a diagram illustrating an e-mail printing service according to an example;

FIG. 3 is a flowchart illustrating an operating method of a server for providing an e-mail printing service according to an example;

FIG. 4 is a diagram illustrating an e-mail printing service according to an example;

FIG. 5 is a flowchart illustrating an operating method of a server for providing an e-mail printing service according to an example;

FIG. 6 is a block diagram illustrating a structure of a server for providing an e-mail printing service according to an example;

FIG. 7 is a block diagram illustrating a structure of a cloud server for providing an e-mail printing service according to an example;

FIG. 8 is a flowchart illustrating an operating method of a cloud server for providing an e-mail printing service according to an example;

FIG. 9 illustrates a reply e-mail according to an example;

FIG. 10 illustrates a print instruction e-mail according to an example;

FIG. 11 illustrates an error e-mail according to an example;

FIG. 12 is a diagram illustrating a service for searching for an image forming apparatus according to an example;

FIG. 13 is a flowchart illustrating an operating method of a server for providing a service for searching for an image forming apparatus according to an example;

FIG. 14 is a diagram illustrating a service for checking an operation state of an image forming apparatus according to an example;

FIG. 15 is a flowchart illustrating an operating method of a server for providing a service for checking an operation state of an image forming apparatus according to an example; and

FIG. 16 is a diagram illustrating an address book registration service according to an example.

### DESCRIPTION OF EXAMPLES

Hereinafter, various examples will be described with reference to the accompanying drawings. The examples described below may be modified and implemented in various different forms.

Although general terms that are currently used are selected to describe the following examples, these terms may vary according to intents or precedents of those skilled in the art, the advent of new technologies, and the like. In addition, in some cases, terms arbitrarily selected by the applicant may be used, and in this case, the meanings of such terms will be described in more detail. Hence, the terms must be defined based on the meanings of the terms and the contents of the entire specification, and not by simply stating the terms themselves.

In the following description, when it is mentioned that an element is “connected” to another element, this includes a case in which both elements are “directly connected to” each other and a case in which “both elements are connected to each other with another element present therebetween.” In addition, when it is mentioned that an element “includes” another element, this is intended not to preclude the presence or addition of one or more other elements, unless otherwise oppositely described. Furthermore, the terms “ . . . unit”, “ . . . module”, and the like as used herein refer to a unit that processes at least one function or operation, and may be implemented as hardware, software, or a combination thereof.

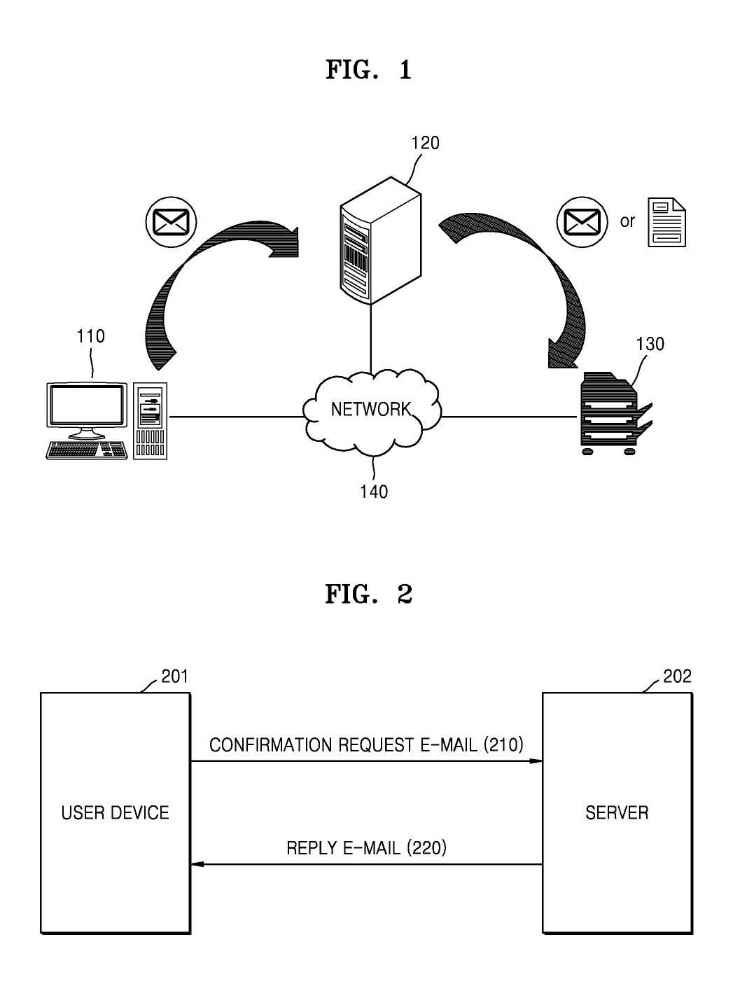

FIG. 1 is a view of a system for providing an e-mail printing service according to an example.

Referring to FIG. 1, a system for providing an e-mail printing service may include a user device 110, a server 120, and an image forming apparatus 130. In the example of FIG. 1, the user device 110, the server 120, and the image forming apparatus 130 are connected to a network 140.

The user device 110 may include any of various devices connectable to a network. For example, the user device 110 may include a personal computer (PC), a notebook computer, a tablet PC, a smartphone, or the like. The user device 110 may include an e-mail client to send an e-mail to the server 120 and receive an e-mail from the server 120. In another example, the user device 110 may include a web browser for using a web mail service. In an example, the user device 110 may send an e-mail to the image forming apparatus 130 via the server 120 or receive an e-mail from the server 120.

The server 120 provides an e-mail printing service. The server 120 may be an e-mail server or a cloud server including an e-mail server and at least one server having other functions. In an example, the server 120 may receive an e-mail to be sent to the image forming apparatus 130 from the user device 110 or may receive an e-mail from the user device 110 and send the e-mail to the image forming apparatus 130. The server 120 may also send an e-mail to the user device 110. Furthermore, the server 120 may communicate with the image forming apparatus 130 and may transmit a print instruction together with print data to the image forming apparatus 130.

The image forming apparatus 130 may include any device capable of performing an image forming job, such as a printer, a copier, a scanner, a fax machine, a multi-function printer (MFP), a display device, or the like. The image forming job may include any job related to an image (e.g., printing, copying, scanning, or faxing) such as image forming or creation/storage/transmission of an image file, and the term “job” may include not only an image forming job, but also include a series of processes needed for performing an image forming job. In an example, the image forming apparatus 130 may be capable of performing a printing job. In an example, the image forming apparatus 130 may include a communication unit to communicate with external devices such as the user device 110 and the server 120. The image forming apparatus 130 may receive a print instruction via the communication unit to perform a printing job.

The network 140 connects the user device 110, the server 120, and the image forming apparatus 130. In an example, the network 140 may include an Internet, an intranet, or the like.

FIG. 2 is a diagram illustrating an e-mail printing service according to an example.

Referring to FIG. 2, in operation 210, a user device 201 sends, to a server 202, a confirmation request e-mail for confirming whether an e-mail address of an image forming apparatus is correct. Upon receiving the confirmation request e-mail, the server 202 confirms whether a recipient address of the received confirmation request e-mail is the e-mail address of the image forming apparatus to create a reply e-mail. In operation 220, the server 202 sends the created reply e-mail to the user device 201.

When a user of the user device 201, who needs to use an e-mail printing service, sends an e-mail, the e-mail address of the image forming apparatus to which a printing job is to be instructed is input as a recipient address. However, for the e-mail address, any character or number may be input as a text input item, and thus when the user inputs a recipient address, there is a possibility for the user to input an incorrect e-mail address.

According to an example, a user who uses the user device 201 may send the confirmation request e-mail and receive the reply e-mail to confirm an accurate e-mail address of an image forming apparatus and send an e-mail to the confirmed address. Thus, unwanted leakage of materials which results from sending of a material to be printed to an incorrect e-mail address may be prevented.

An example will be described below in more detail.

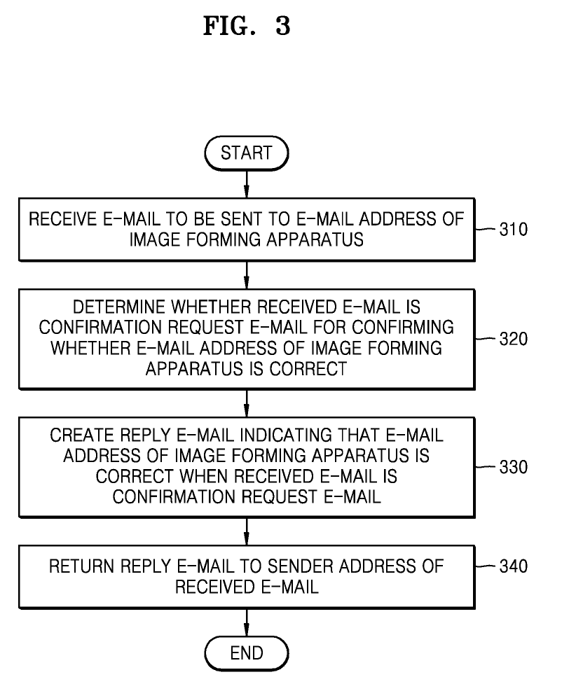

FIG. 3 is a flowchart illustrating an operating method of a server for providing an e-mail printing service according to an example.

Referring to FIG. 3, the server 202 receives an e-mail to be sent to an e-mail address of an image forming apparatus in operation 310. As an example, a user of the user device 201, who needs to use an e-mail printing service, sends an e-mail to an e-mail address of a remote image forming apparatus to which printing is to be instructed. The user may use the user device 201 to access an e-mail client program or a web mail service and send an e-mail. The server 202 may receive the corresponding e-mail in an intermediate process in which the e-mail sent from the user device 201 is sent to an image forming apparatus. Thus, when the user sends an e-mail to the e-mail address of the image forming apparatus even though the user does not know an e-mail address of the server 202, the server 202 may receive the e-mail being sent.

The server 202 may be an e-mail server including an incoming e-mail server and an outgoing e-mail server, or a cloud server including an e-mail server. In this regard, the e-mail server may be an e-mail server that manages the e-mail address of an image forming apparatus.

In operation 320, the server 202 determines whether the received e-mail is a confirmation request e-mail for confirming whether the e-mail address of the image forming apparatus is correct. The server 202 may determine whether the e-mail received using a predetermined method is the confirmation request e-mail. In an example, the server 202 may determine that the received e-mail is the confirmation request e-mail when there is at least one of no subject, no content, or no attached file in the received e-mail. However, this method is merely an example, and the present disclosure is not limited thereto. It may be determined using various other methods that the received e-mail is the confirmation request e-mail.

When the server 202 is a cloud server, the server 202 may include a separate e-mail analysis server for determining whether the received e-mail is the confirmation request e-mail.

In operation 330, when the received e-mail is the confirmation request e-mail, the server 202 creates a reply e-mail indicating that the e-mail address of the image forming apparatus is correct. In more detail, upon receiving an e-mail, the server 202 determines whether a recipient address of the received e-mail is an e-mail address registered in the server 202. When the recipient address is the registered e-mail, the server 202 determines whether the recipient address is the e-mail address of the image forming address. When the recipient address is the e-mail address of the image forming apparatus, the server 202 determines whether the received e-mail is the confirmation request e-mail. This will be described below in further detail. According to the above-described process, the fact that the server 202 has received the e-mail to be sent to the e-mail address of the image forming apparatus means that the recipient address has been correctly written as the e-mail address of the image forming apparatus, and thus the server 202 may create a reply e-mail indicating that the e-mail address of the image forming apparatus is correct.

In an example, the server 202 may create a reply e-mail including information of the image forming apparatus. In this regard, the information of the image forming apparatus may include at least one of a physical address, state information, attribute information, or the like of the image forming apparatus. The server 202 records the physical address of the image forming apparatus in the reply e-mail so that the corresponding user can determine whether a printer to be used for printing is correct or whether the corresponding printer is in a desired position. Further, the server 202 may record the state information and/or attribute information of the image forming apparatus in the reply e-mail so that the user can determine whether printing is possible and set a printing option.

In operation 340, the server 202 returns the reply e-mail to a sender address of the received e-mail. In this regard, the server 202 may reply to the e-mail instead of sending a new e-mail such that the server 202 sends a reply e-mail using the sender address as the e-mail address of the image forming apparatus. By receiving the reply e-mail, the user may confirm the e-mail address of the image forming apparatus and send an e-mail to the confirmed address. The user may confirm information of the image forming apparatus included in the reply e-mail and accurately perform a printing job in the image forming apparatus to be used for the printing job. In an example, the server 202 may return the reply e-mail within a predetermined time period. Since the user who has sent the confirmation request e-mail is waiting for the printing job, a time limit for sending the reply e-mail may be set for user convenience. However, although the time limit is set, the server 202 may send the reply e-mail as soon as possible.

According to an example, the user may safely perform a printing job at a desired printing position.

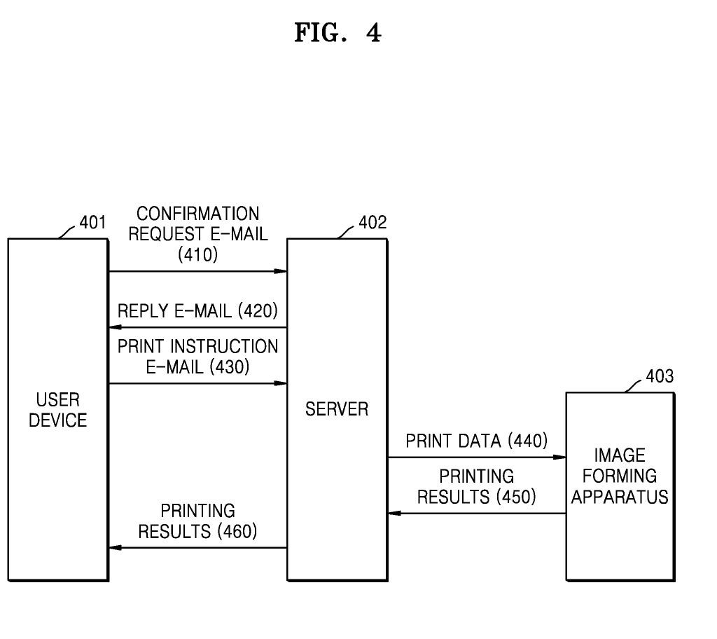

FIG. 4 is a diagram illustrating an e-mail printing service according to an example.

Referring to FIG. 4, operations 410 and 420 are the same as operations 210 and 220 of FIG. 2, and thus a description thereof will be briefly provided herein.

In operation 410, a user device 401 sends, to a server 402, a confirmation request e-mail for confirming whether an e-mail address of an image forming apparatus 403 is correct. In operation 420, the server 402 sends, to the user device 401, a reply e-mail indicating that the e-mail address of the image forming apparatus 403 is correct.

In operation 430, the user device 401 sends a print instruction e-mail along with print data to the server 402. In the print instruction e-mail, a user may confirm through the reply e-mail that the e-mail address of the image forming apparatus 403 is correct and may confirm through information of the image forming apparatus 403 included in the reply e-mail that the image forming apparatus 403 is ready to be used for printing. Therefore, the user sends print data and the print instruction e-mail for instructing a printing job via the user device 401.

In operation 440, the server 402 having received the print instruction e-mail transmits the print data to the image forming apparatus 403 and instructs the image forming apparatus 403 to perform the printing job. In this regard, the server 402 may convert the print data into a format printable in the image forming apparatus 403 and transmit the data to the image forming apparatus 403. In addition, when setting information for setting an attribute of the image forming apparatus 403 is included in the print instruction e-mail, the server 402 may instruct the image forming apparatus 403 to perform the printing job in accordance with the setting information. In an example, the server 402 may send, to the image forming apparatus 403, a notification that the print data has been received, and the image forming apparatus 403 having received the notification may access an image forming apparatus management server included in the server 402 to receive the print data. As an example of receiving the print data, the image forming apparatus management server may transmit the print data to the image forming apparatus 403 via a push, or the image forming apparatus 403 may download the print data of the image forming apparatus management server. However, this is merely an example and the present disclosure is not limited thereto. That is, the print data may be transmitted using various methods.

Based on transmission of the print data, the image forming apparatus 403 starts to perform a printing job. The start point of the printing job may vary according to a user setting such that the printing job may be started upon reception of the print data, immediately after completion of the transmission of the print data, after the user reaches the image forming apparatus 403 and presses a start button, after the user completes an authentication, or the like. However, these are merely examples, and the present disclosure is not limited thereto. The print start point of the print data may be set using various methods.

In operation 450, the image forming apparatus 403 may transmit the printing results to the server 402. When the server 402 receives the printing results, the server 402 may transmit the printing results to the user device 401 in operation 460.

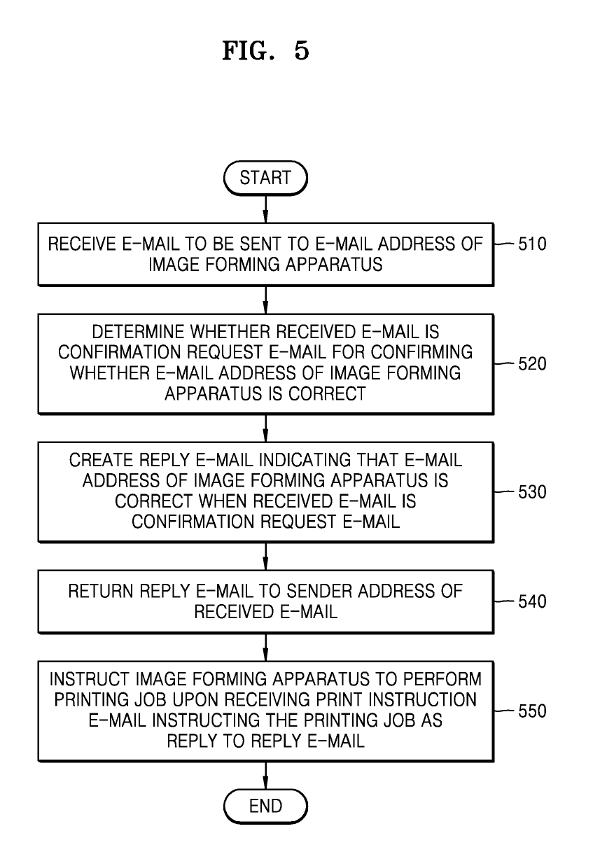

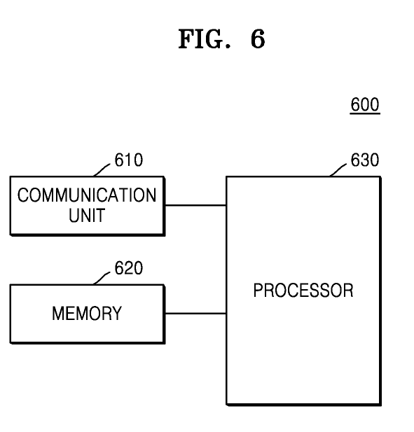

FIG. 5 is a flowchart illustrating an operating method of a server for providing an e-mail printing service according to an example.

Referring to FIG. 5, operations 510 to 540 are the same as operations 310 to 340 of FIG. 3, and thus a description thereof will be briefly provided herein.

In operation 510, the server 402 receives an e-mail to be sent to an e-mail address of the image forming apparatus 403. In operation 520, the server 402 determines whether the received e-mail is a confirmation request e-mail for confirming whether the e-mail address of the image forming apparatus 403 is correct. In operation 530, when the received e-mail is the confirmation request e-mail, the server 402 creates a reply e-mail indicating that the e-mail address of the image forming apparatus 403 is correct. In operation 540, the server 402 returns the reply e-mail to a sender address of the received e-mail.

In operation 550, when the server 402 receives, as a reply to the reply e-mail, print data and a print instruction e-mail that instructs a printing job, the server 402 may instruct the image forming apparatus 403 to perform the printing job. The server 402 may determine whether the content of the print instruction e-mail and the attached file are printable. When the server 402 includes an e-mail analysis server, such a determination process may be performed in the e-mail analysis server. When the server 402 determines that the content of the print instruction e-mail and the attached file are printable, the server 402 transmits the print data to the image forming apparatus 403 to instruct the printing job. In an example, the server 402 may convert the print data into a format printable in the image forming apparatus 403 and transmit the data to the image forming apparatus 403. In an example, the server 402 may include an emulation server configured to emulate the print data received from the user device 401 into a format printable in the image forming apparatus 403. In addition, when setting information for setting an attribute of the image forming apparatus 403 is included in the print instruction e-mail, the server 402 may instruct the image forming apparatus 403 to perform the printing job in accordance with the setting information.

An operating method of a server for providing an e-mail printing service, according to an example has been described. Hereinafter, example configurations of a server for providing an e-mail printing service will be described in more detail. The description of the same configurations as those described above will be briefly provided herein.

FIG. 6 is a block diagram illustrating a structure of a server for providing an email printing service according to an example.

Referring to FIG. 6, a server 600 includes a communication unit 610, a memory 620, and a processor 630.

The communication unit 610 may perform wired/wireless communication with another device or a network. To this end, the communication unit 610 may include a communication module (e.g., transceiver) that supports at least one of various wired/wireless communication methods. For example, the communication module may be in the form of a chipset.

The communication unit 610 may be connected to an external device located outside the server 600 and transmit and receive signals or data thereto or therefrom. The server 600 may be connected to the external device via the communication unit 610 and transmit signals or data received from the external device to the processor 630, or transmit signals or data generated from the processor 630 to the external device. For example, the communication unit 610 may receive an e-mail from a user device or send an e-mail to the user device. In addition, the communication unit 610 may instruct an image forming apparatus to perform a printing job.

Various types of data such as programs (e.g., applications), files, and the like may be installed and stored in the memory 620. The processor 630 may access and use data stored in the memory 620 or may store new data in the memory 620. The processor 630 may also execute a program installed in the memory 620.

In an example, a program for providing an e-mail printing service may be stored in the memory 620.

The processor 630 may control an operation of the server 600. As an example, the processor 630 may control the server 600 to provide an e-mail printing service. In addition, the processor 630 may store signals or data input from the outside of the server 600 or may be operated using a random access memory (RAM) used as a storage area corresponding to various jobs performed in the server 600, a read-only memory (ROM) that stores a control program for controlling peripheral devices, or the like. The processor 630 may be implemented as a system on chip (SoC) that integrates a core and a graphics processing unit (GPU). In addition, the processor 630 may include a plurality of processors.

The processor 630 may receive an e-mail to be sent to an e-mail address of an image forming apparatus and may determine whether the received e-mail is a confirmation request e-mail for confirming whether the e-mail address of the image forming apparatus is correct. In addition, when the received e-mail is the confirmation request e-mail, the processor 630 may create a reply e-mail indicating that the e-mail address of the image forming apparatus is correct and may control the server 600 to return the reply e-mail to a sender address of the received e-mail.

When the processor 630 receives, as a reply to the reply e-mail, print data and a print instruction e-mail indicating a printing job, the processor 630 may instruct the image forming apparatus to perform the printing job. In this regard, the processor 630 may convert the print data into a format printable in the image forming apparatus and transmit the data to the image forming apparatus.

When setting information for setting the attribute of the image forming apparatus is included in the print instruction e-mail, the processor 630 may instruct the image forming apparatus to perform the printing job in accordance with the setting information. In addition, the processor 630 may determine that the received e-mail is the confirmation request e-mail when there is at least one of no subject, no content, or no attached file in the received e-mail. Furthermore, the processor 630 may create a reply e-mail including information of the image forming apparatus. In this regard, the information of the image forming apparatus may include at least one of a physical address, state information, or attribute information of the image forming apparatus. In addition, the processor 630 may return the reply e-mail within a predetermined time period.

The processor 630 may receive a search e-mail including location information of a user to search for a nearby image forming apparatus, search for an image forming apparatus around the user, and return a list of the image forming apparatus around the user to a sender address of the search e-mail.

The processor 630 may receive a confirmation e-mail for confirming an operation state of an image forming apparatus connected to a server, confirm the operation state of the image forming apparatus, and return the operation state of the image forming apparatus to a sender address of the confirmation e-mail.

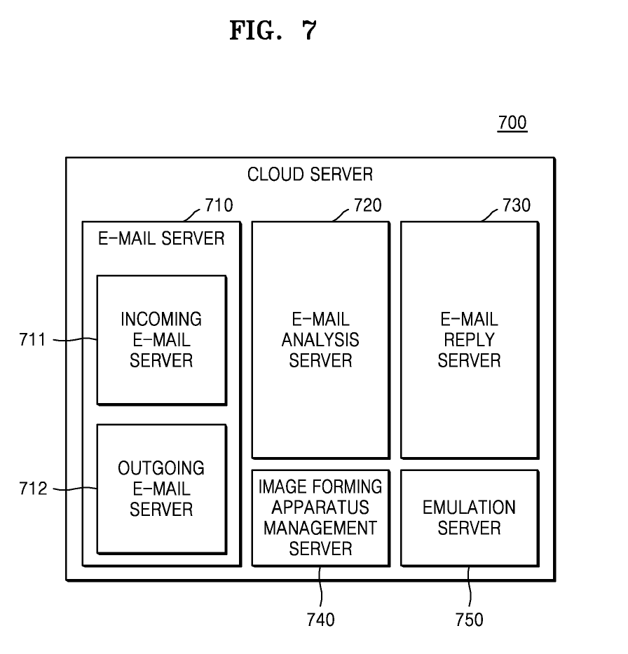

FIG. 7 is a block diagram illustrating a structure of a cloud server for providing an e-mail printing service according to an example.

Referring to FIG. 7, a cloud server 700 may include an e-mail server 710 including an incoming e-mail server 711 and an outgoing e-mail server 712, an e-mail analysis server 720, an e-mail reply server 730, an image forming apparatus management server 740, and an emulation server 750.

The e-mail server 710 including the incoming e-mail server 711 and the outgoing e-mail server 712 sends and receives an e-mail. The e-mail analysis server 720 analyzes the received e-mail. The e-mail reply server 730 may send a reply in accordance with analysis results of the received e-mail. The image forming apparatus management server 740 plays a role in managing the image forming apparatus, such as registration of the image forming apparatus, confirmation of a state of the image forming apparatus, transmission of print data to the image forming apparatus, or the like. The emulation server 725 converts the print data into a format printable in the image forming apparatus.

Although FIG. 7 illustrates that the cloud server 700 includes separate servers according to functions, this is merely an example, and one server may perform two or more functions. For example, a single server may implement a function of the e-mail analysis server 720 to analyze an e-mail received in the server and determine whether the received e-mail is a confirmation request e-mail and a function of the e-mail reply server 730 to send a reply in accordance with analysis results of the received e-mail.

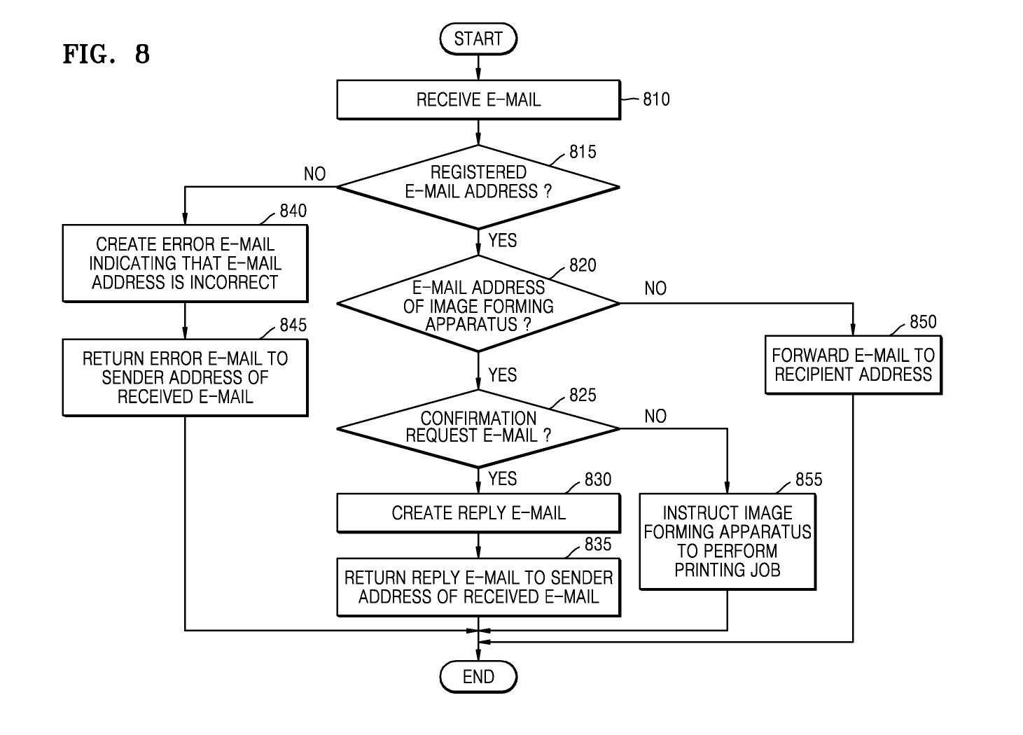

FIG. 8 is a flowchart illustrating an operating method of a cloud server for providing an e-mail printing service according to an example.

Referring to FIG. 8, the cloud server 700 receives an e-mail from a user device via the incoming e-mail server 711 in operation 810.

In operation 815, the e-mail analysis server 720 analyzes the received e-mail and determines whether a recipient address of the received e-mail is an address registered in the incoming e-mail server 711. This is intended to determine whether the received e-mail is an e-mail that can be normally sent.

In operation 815, when the e-mail analysis server 720 determines that the recipient address of the received e-mail is the address registered in the incoming e-mail server 711, the process proceeds to operation 820. In operation 820, the e-mail analysis server 720 determines whether the recipient address of the received e-mail is an e-mail address of an image forming apparatus. A plurality of e-mail addresses may be registered in the incoming e-mail server 711 of the cloud server 700. Thus, since e-mail addresses of other devices or specific users as well as the image forming apparatus are also registered, whether the e-mail is an e-mail to be sent to the image forming apparatus is determined.

In operation 820, when the e-mail analysis server 720 determines that the recipient address of the received e-mail is the e-mail address of the image forming apparatus, the process proceeds to operation 825. In operation 825, the e-mail analysis server 720 determines whether the received e-mail is a confirmation request e-mail for confirming whether the e-mail address of the image forming apparatus is correct. This is intended to confirm whether a user sends an e-mail to directly request a printing job or a user sends an e-mail to confirm whether the e-mail address is correct.

In operation 825, when the e-mail analysis server 720 determines that the received e-mail is the confirmation request e-mail, the process proceeds to operation 830. In operation 830, the e-mail reply server 730 creates a reply e-mail indicating that the e-mail address of the image forming apparatus is correct, and in operation 835, the e-mail reply server 730 returns a reply e-mail to a sender address of the received e-mail.

In operation 825, when the e-mail analysis server 720 determines that the received e-mail is not the confirmation request e-mail, the process proceeds to operation 855. When the received e-mail is not the confirmation request e-mail, it may be determined that the received e-mail is an e-mail for a direct print request. Accordingly, in operation 855, print data attached in the e-mail received in the emulation server 750 is converted into a format printable in the image forming apparatus and is transmitted to the image forming apparatus via the image forming apparatus management server 740.

In operation 820, when the e-mail analysis server 720 determines that the recipient address of the received e-mail is not the e-mail address of the image forming apparatus, the process proceeds to operation 850 to send the e-mail to the recipient address.

In operation 815, when the e-mail analysis server 720 determines that the recipient address of the received e-mail is not an address registered in the incoming e-mail server 711, the process proceeds to operation 840. When the recipient address of the received e-mail is not an address registered in the incoming e-mail server 711, the recipient address is incorrect from the beginning so that the received e-mail cannot be sent. Accordingly, in operation 840, the e-mail reply server 730 creates an error e-mail indicating that the e-mail address is incorrect, and in operation 845, the e-mail reply server 730 returns the error e-mail to a sender address of an e-mail received via the outgoing e-mail server 712. When the recipient address of the received e-mail is not an address registered in the incoming e-mail server 711, the recipient address is incorrect from the beginning so that the received e-mail cannot be sent. In operation 815, a confirmation analysis is performed on these e-mails.

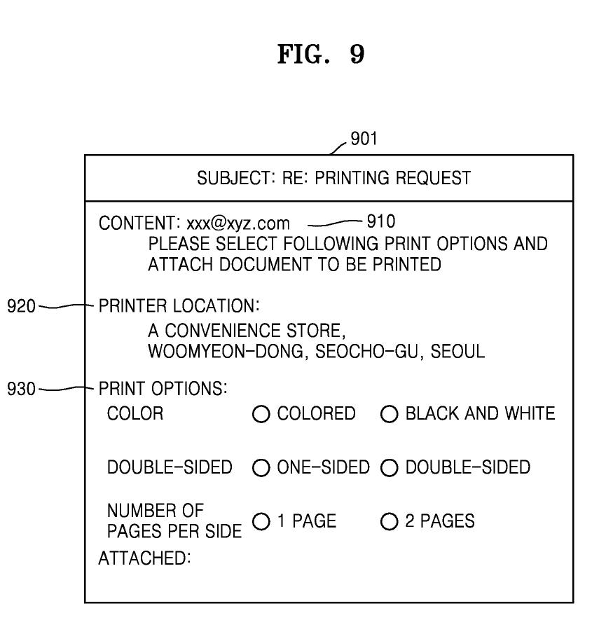

FIG. 9 illustrates a reply e-mail according to an example.

Referring to FIG. 9, a reply e-mail 901 includes a text for confirming a recipient address 910 of a confirmation request e-mail so that it can be confirmed that an e-mail address of an image forming apparatus is correct. In addition, the reply e-mail 901 includes a printer position 920 so that a user can confirm whether a printer ready to be used for printing is correct or the corresponding printer is in a desired position. Furthermore, the reply e-mail 901 includes an item for setting a print option 930 so that a user who has received the reply e-mail 901 can conveniently set the print option 930.

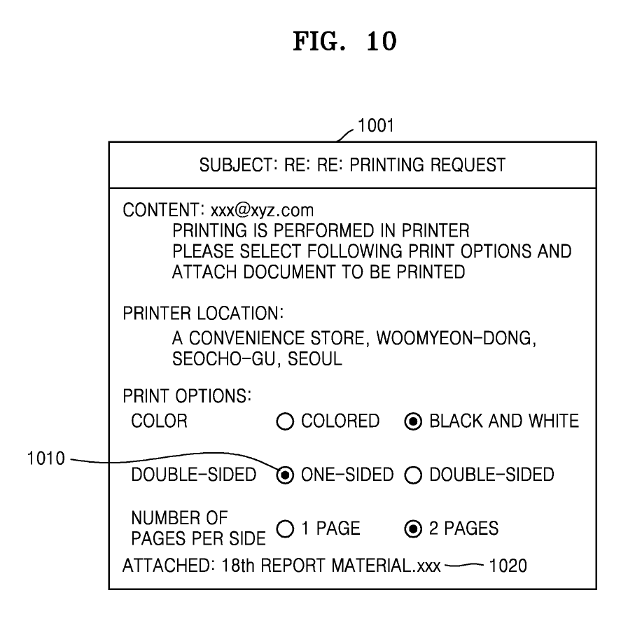

FIG. 10 illustrates a print instruction e-mail according to an example.

Referring to FIG. 10, a print instruction e-mail 1001 may display print option items 1010 selected by a user. In addition, print data may be attached as an attached file 1020. When a server determines that the content of the print instruction e-mail 1001 and the attached file 1020 are printable, the server transmits the print data to an image forming apparatus based on the print instruction e-mail 1001 and instructs the image forming apparatus to perform a printing job.

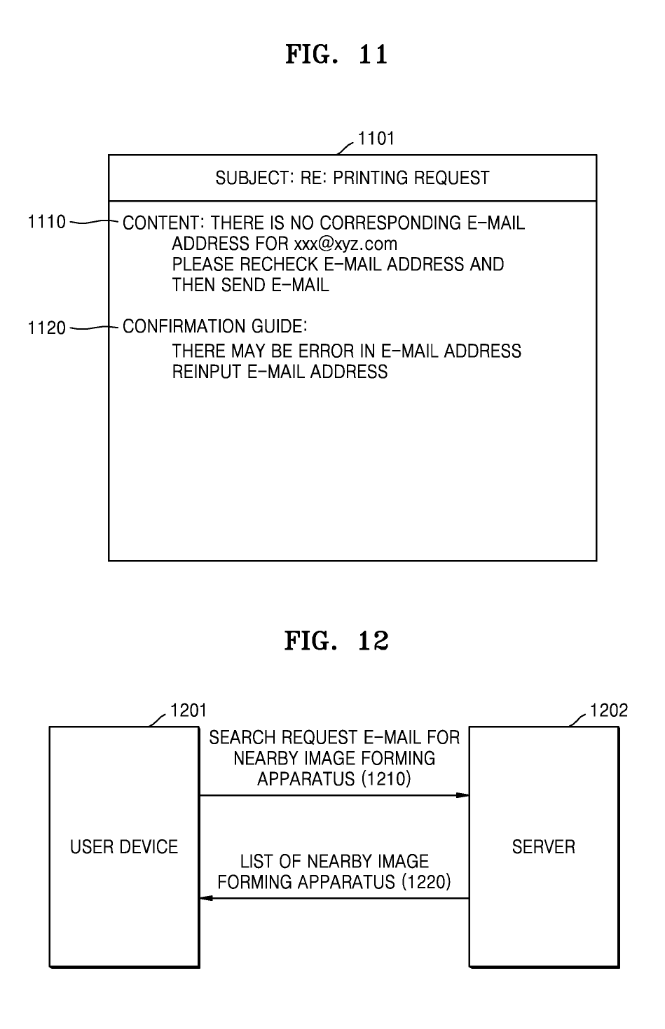

FIG. 11 illustrates an error e-mail according to an example.

Referring to FIG. 11, an error e-mail 1101 includes content 1110 for confirming a recipient address of a confirmation request e-mail so that it can be confirmed that an e-mail address of an image forming apparatus is incorrect. In addition, the error e-mail 1101 may include a guide text 1120 such as a solution related to an error, or the like.

The drawings of FIGS. 9 to 11 are merely examples and the present disclosure is not limited thereto. Rather, an e-mail may be displayed using various methods.

FIG. 12 is a diagram illustrating a service for searching for an image forming apparatus according to an example.

Referring to FIG. 12, a user device 1201 sends a search request e-mail including location information of a user to a server 1202 to search for a nearby image forming apparatus in operation 1210. When the server 1202 receives the search request e-mail, an image forming apparatus around a user is searched for based on the location information of the user included in the search request e-mail. In operation 1220, the server 1202 returns an item of the image forming apparatus around the user to a sender address of the search request e-mail.

According to an example, the user may search whether there is an image forming apparatus available around the user. Accordingly, when an e-mail printing service is needed, a printer that supports a nearby e-mail printing service may be simply searched for even though an accurate position and e-mail address of the printer are unknown.

An example will be described below in more detail.

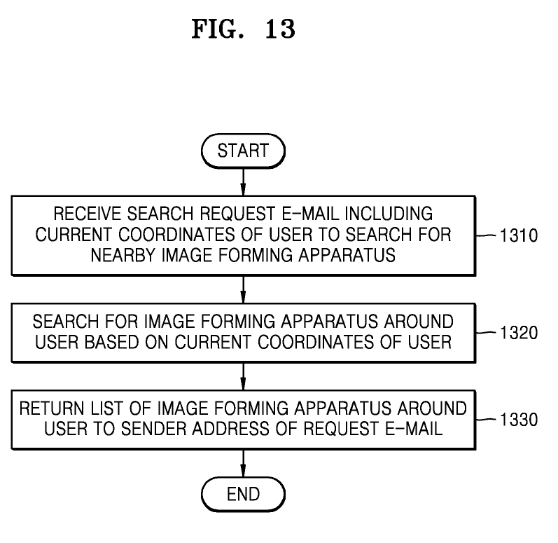

FIG. 13 is a flowchart illustrating an operating method of a server for providing a service for searching for an image forming apparatus according to an example.

Referring to FIG. 13, the server 1202 may receive a search request e-mail including location information of a user to search for a nearby image forming apparatus in operation 1310. In an example, the server 1202 may assign a specific e-mail to support a service that searches for a nearby image forming apparatus. For example, an e-mail address such as search@xxx.com or find@xxx.com may be previously created and registered in an e-mail server. The server 1202 may receive from a user an e-mail including location information with the assigned e-mail address. The location information may be represented by, for example, Yangjae-dong, Seocho-gu, Seoul, GPS coordinates, a surrounding address, or the like.

In operation 1320, the server 1202 searches for an image forming apparatus around a user based on the location information of the user. More particularly, the server 1202 may analyze content of the received search request e-mail, a sender header, server information, or the like to identify the location of the user and may search for the image forming apparatus around the user. For example, the server 1202 may specify the location with information sent using an e-mail server and internet protocol (IP) address located in Korea. In addition, the server 1202 may search for printer information held by a printer management server by using, as a search word, a street address, GPS coordinates, a store name, or an address written by a user in the e-mail body.

In operation 1330, the server 1202 may return a list of the image forming apparatus around the user to a sender address of the search request e-mail. The server 1202 may create a list of search results obtained in operation 1320 and return the list to the user. The user may check the returned printer e-mail list to select an image forming apparatus ready to be used for printing and send an e-mail to the selected image forming apparatus to use an e-mail printing service.

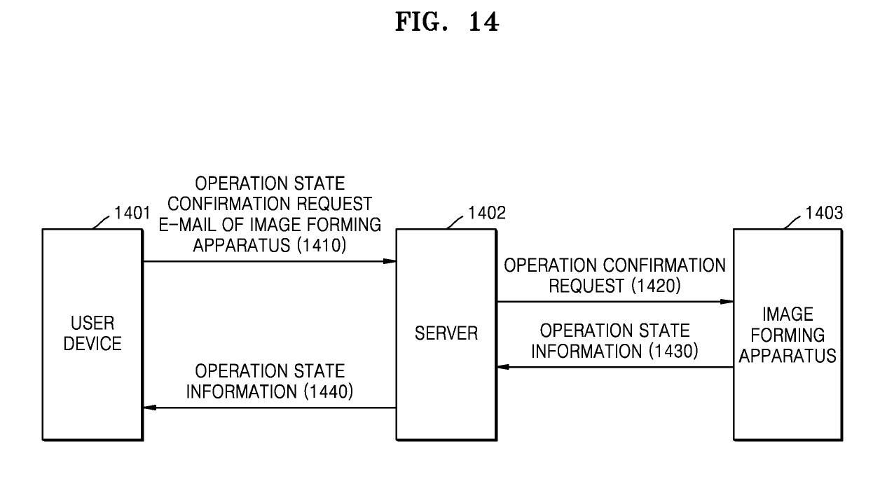

FIG. 14 is a diagram illustrating a service for checking an operation state of an image forming apparatus according to an example.

Referring to FIG. 14, in operation 1410, a user device 1401 sends, to a server 1402, an operation state confirmation request e-mail for confirming an operation state of an image forming apparatus 1403 connected to the corresponding server 1402. In operation 1420, upon receiving the operation state confirmation request e-mail, the server 1402 sends an operation confirmation request to the image forming apparatus 1403 connected to the corresponding server 1402, and in operation 1430, the server 1402 receives operation state information. In operation 1440, the server 1402 returns the operation state information of the image forming apparatus 1403 to a sender address of the operation state confirmation request e-mail.

According to an example, a user may conveniently confirm whether the registered image forming apparatus is normally registered or is normally operated.

An example will be described below in more detail.

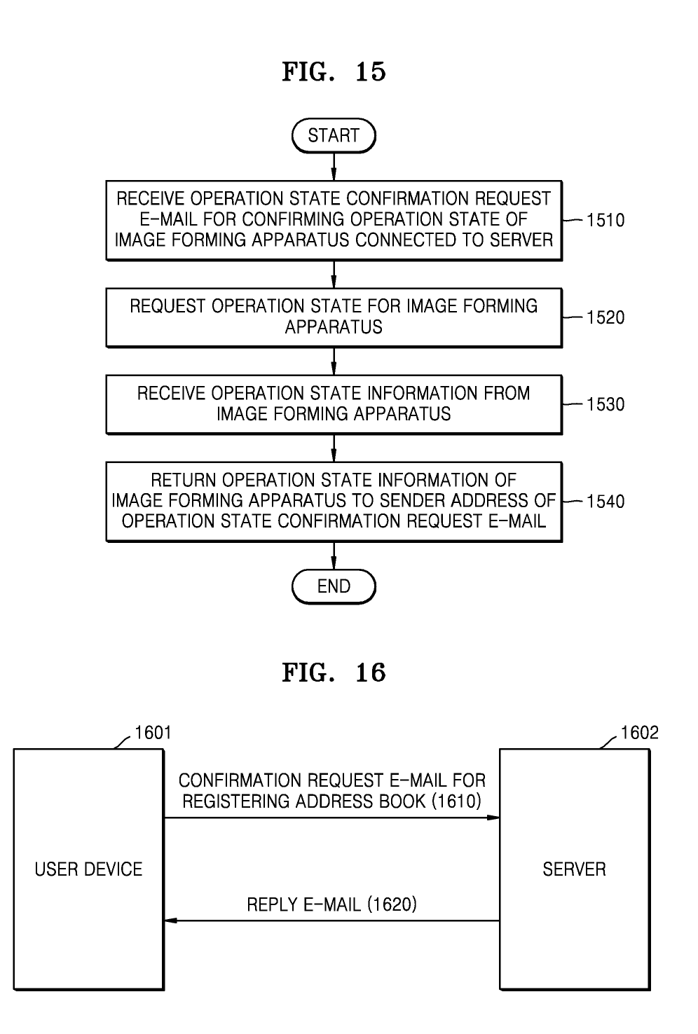

FIG. 15 is a flowchart illustrating an operating method of a server for providing a service for checking an operation state of an image forming apparatus according to an example.

Referring to FIG. 15, the server 1402 may receive an operation state confirmation request e-mail for confirming an operation state of the image forming apparatus 1403 connected to the corresponding server 1402 in operation 1510. In an example, the server 1402 may assign a specific e-mail to support an operation state confirmation service of the image forming apparatus 1403. For example, an e-mail address such as status@xxx.com or management@xxx.com may be previously created and registered in an e-mail server. The server 1402 may receive from a user an operation state confirmation request e-mail with the assigned e-mail address.

In operation 1520, the server 1402 may send an operation confirmation request to the image forming apparatus 1403, and in operation 1530, the server 1402 may receive operation state information. The operation state information may include a registration position, an attribute, a current state, billing information, a setting, or the like of the image forming apparatus 1403.

In operation 1540, the server 1402 may return the operation state information of the image forming apparatus 1403 to a sender address of the operation state confirmation request e-mail. The user may confirm the returned operation state information of the image forming apparatus 1403, thereby confirming an operation state thereof without directly moving to the image forming apparatus 1403.

FIG. 16 is a diagram illustrating an address book registration service according to an example.

Referring to FIG. 16, a user device 1601 sends a confirmation request e-mail for registering an address book to a server 1602 in operation 1610. According to an example, a user may create an address book to use a printer that supports an e-mail printing service. For the e-mail address, any character or number may be input as a text input item, and thus when a user directly inputs an e-mail address, there is a possibility for the user to input an incorrect e-mail address. When an incorrect e-mail address is input in the address book, a print request may be continuously sent using the incorrect e-mail address, resulting in the occurrence of security vulnerability. To prevent this, after inputting an e-mail address to the address book, a confirmation request e-mail for registering the address book may be sent to the server 1602.

In operation 1620, the server 1602 may confirm whether the received address is an e-mail address of an image forming apparatus and return a reply e-mail indicating that the e-mail address is correct to a sender address of the request e-mail. Upon receiving the confirmation request e-mail, the server 1602 confirms whether the image forming apparatus corresponding to a recipient address of the confirmation request e-mail is registered in the server 1602. When the image forming apparatus is registered in the server 1602, the reply e-mail indicating that the e-mail address is correct returns to the sender address of the request e-mail.

The operations of FIG. 16 may be performed automatically through an exclusive address book program or application that supports e-mail printing.

According to an example, a user who uses the user device 1601 may send the confirmation request e-mail and receive the reply e-mail to register the correct e-mail address of the image forming apparatus in the address book. Thus, unwanted leakage of materials which may result from sending of material to be printed to an incorrect e-mail address may be prevented.

An apparatus according to the examples may include a processor, a memory to store and execute program data, a permanent storage unit such as a disk drive, a communication port to communicate with external devices, and a user interface device such as a touch panel, keys, and buttons. Methods implemented as software modules or algorithms may be stored as computer-readable codes or program instructions executable on the processor on a non-transitory computer-readable recording medium. Here, examples of the non-transitory computer-readable recording medium may include a magnetic storage medium (e.g., a read-only memory (ROM), a random-access memory (RAM), a floppy disk, a hard disk, or the like) and optical reading medium (e.g., a compact disk (CD)-ROM, a digital versatile disc (DVD), or the like). The non-transitory computer-readable recording medium may be distributed over network coupled computer systems so that the computer-readable code may be stored and executed in a distributed fashion. The non-transitory computer-readable recording medium may be read by the computer, stored in the memory, and executed by the processor.

The above examples may be described in terms of functional block components and various processing operations. Such functional blocks may be realized by any number of hardware and/or software components configured to perform the specified functions. For example, examples may employ various integrated circuit components, e.g., memory elements, processing elements, logic elements, look-up tables, and the like, which may carry out a variety of functions under the control of one or more microprocessors or other control devices. Similarly, where elements are implemented using software programming or software elements, the examples may be implemented with any programming or scripting language, such as C, C++, Java, assembler, or the like, with various algorithms being implemented with any combination of data structures, processes, routines, or other programming elements. Functional aspects may be implemented in algorithms that execute on one or more processors. Furthermore, the examples may employ any number of conventional techniques for electronics configuration, signal processing, and/or data processing. The terms “mechanism”, “element”, “means”, and “configuration” may be broadly used, and are not limited to mechanical and physical configurations. The above terms may include the meanings of software routines in connection with processors and the like.

The particular implementations described above are illustrative examples and are not intended to otherwise limit the scope of the disclosure in any way. For the sake of brevity, existing electronics, control systems, software, and other functional aspects of the systems may not be described in detail. In addition, the connecting lines, or connectors shown in the various figures presented are intended to represent exemplary functional relationships and/or physical or logical couplings between the various elements. It should be noted that many alternative or additional functional relationships, physical connections or logical connections, may be present in a practical device.

The use of the term “the” and similar referents in the present specification (especially in the following claims) are to be construed to cover both the singular and the plural. Furthermore, recitations of ranges are merely intended to refer individually to each separate value falling within the range, unless otherwise indicated herein, and each separate value is incorporated into the specification as if it were individually recited herein. Finally, the processes of all methods described herein may be performed in any suitable order unless otherwise indicated herein or otherwise clearly contradicted by context. The description order of the above processes is not limited thereto. The use of any and all examples, or exemplary language (e.g., “such as”) provided herein, is intended merely to better illustrate the disclosure and does not pose a limitation on the scope of the disclosure unless otherwise claimed. It will also be appreciated by those skilled in the art that various modifications, combinations, and alterations may be made depending on design criteria and factors within the scope of the appended claims or equivalents thereto.

What is claimed is:

1. An operating method of a server for providing an e-mail printing service, the method comprising:
receiving an e-mail to be sent to an e-mail address of an image forming apparatus;
determining whether the received e-mail is a confirmation request e-mail for confirming whether the e-mail address of the image forming apparatus is correct;
creating a reply e-mail when the received e-mail is the confirmation request e-mail, the reply e-mail indicating that the e-mail address of the image forming apparatus is correct; and
returning the reply e-mail to a sender address of the received e-mail.

2. The operating method of claim 1, further comprising instructing the image forming apparatus to perform a printing job upon receiving print data and a print instruction e-mail as a reply to the reply e-mail, wherein the print instruction e-mail instructs the printing job.

3. The operating method of claim 2, wherein the instructing of the image forming apparatus to perform a printing job comprises:
converting the print data into a format printable in the image forming apparatus; and
transmitting the data to the image forming apparatus.

4. The operating method of claim 2, wherein the instructing of the image forming apparatus to perform a printing job comprises, when the print instruction e-mail includes setting information for setting an attribute of the image forming apparatus, instructing the image forming apparatus to perform a printing job in accordance with the setting information.

5. The operating method of claim 1, wherein the determining of whether the received e-mail is a confirmation request e-mail comprises determining that the received e-mail is the confirmation request e-mail when there is at least one of no subject, no content, or no attached file in the received e-mail.

6. The operating method of claim 1, wherein the creating of the reply e-mail when the received e-mail is the confirmation request e-mail comprises creating the reply e-mail including information of the image forming apparatus.

7. The operating method of claim 6, wherein the information of the image forming apparatus includes at least one of a physical address, state information, or attribute information of the image forming apparatus.

8. The operating method of claim 1, wherein the returning of the reply e-mail to the sender address of the received e-mail comprises returning the reply e-mail within a predetermined time period.

9. The operating method of claim 1, further comprising:
receiving a search request e-mail, the search request e-mail including location information of a user to search for an image forming apparatus around a user;
searching for the image forming apparatus around the user based on the location information of the user; and
returning a list of the image forming apparatus around the user to a sender address of the search request e-mail.

10. The operating method of claim 1, further comprising:
receiving an operation state confirmation request e-mail for confirming an operation state of the image forming apparatus connected to the server;
confirming the operation state of the image forming apparatus; and
returning operation state information of the image forming apparatus to a sender address of the operation state confirmation request e-mail.

11. A server for providing an e-mail printing service, the server comprising:
a communication unit;
a memory; and
a processor to:
receive an e-mail to be sent to an e-mail address of an image forming apparatus by executing a program for providing the e-mail printing service,
determine whether the received e-mail is a confirmation request e-mail for confirming whether the e-mail address of the image forming apparatus is correct,
create a reply e-mail indicating that the e-mail address of the image forming apparatus is correct when the received e-mail is the confirmation request e-mail, and
return the reply e-mail to a sender address of the received e-mail.

12. The server of claim 11, wherein the processor instructs the image forming apparatus to perform a printing job upon receiving print data and a print instruction e-mail as a reply to the reply e-mail, the print instruction e-mail instructing the printing job.

13. The server of claim 12, wherein the processor converts the print data into a format printable in the image forming apparatus and transmits the data to the image forming apparatus.

14. The server of claim 12, wherein, when the print instruction e-mail includes setting information for setting an attribute of the image forming apparatus, the processor instructs the image forming apparatus to perform a printing job in accordance with the setting information.

15. The server of claim 11, wherein the processor determines that the received e-mail is the confirmation request e-mail when there is at least one of no subject, no content, or no attached file in the received e-mail.
